(19) United States
(12) Patent Application Publication
(10) Pub. No.: US 2003/0236963 A1
(43) Pub. Date: Dec. 25, 2003

(54) Method for fetching word instruction in a word-based processor and circuit to perform the same

(76) Inventor: Mike Ryken, San Jose, CA (US)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/064,239

(22) Filed: Jun. 25, 2002

(51) Int. Cl. G06F 9/30; G06F 9/40

(52) U.S. Cl. 712/204; 712/205

(57) ABSTRACT

The invention is directed to a method for fetching at least one word instruction in a word-based processor. The word instruction includes several types of a full-word instruction or a half-word instruction. The processor employs a data bus with a word length in bit. The method includes dividing the word length into a plurality of world units by 2ⁿ bits. The processor checks the memory request to obtain whether or not the word instruction to be fetched is in a sequential half-word aligned address. If it is, then the processor fetches the sequential multiple half-word instructions at the same time in full word length at a first fetch cycle. The half-word instructions are stored in the word units. Then, the half-word instructions are executed without directly fetching the half-word instructions from the memory in each the fetch cycles. A circuit is also provided to fetch the word instruction.

### BACKGROUND OF THE INVENTION

1. Field of Invention

The present invention relates to technology of word processor. More particularly, the present invention relates to a method for fetching half-word instructions in a word-based processor and the circuit to perform the method. Thus, the power consumption can be effectively saved.

2. Description of Related Art

In a conventional data processor, usually a process is divided into several processing steps with a flow of data processing. The processing step of different instructions are performed at the same time in respective corresponding stages of the pipeline. The data processing systems basically utilizes a processor core operation under control of program instruction words, which when decoded serve to generate control signals tp control the different elements within the processor core to perform the necessary functions to achieve the processing specified in the program instruction words.

In order to execute the instruction words, the processor usually has to fetch the words through the data bus. In the early stage of the computer, the size of the data bus is 8-bits or 16-bits. In that case, the computer will takes a long time to execute the instructions. That is because the size of the bits is not sufficient to identify the each instruction. One instruction usually needs several decoding steps. Nowadays, since the semiconductor fabrication technology is greatly developed, the computer system can be operated in 64-bit, which can independently assign the different complicate instructions. As a result, the operation speed can be greatly improved.

Instructions usually are stored to and fetched from a memory using an address. The word size is the typical length of an instruction in bits, such as 64-bit for the current design. For the type of word-based processor in conventional manner, it fetches half-word instructions by fetching one instruction for every fetch cycle. In other words, the processor in every cycle needs an instruction, which cause to send a request to the memory system. The memory system will return each half-word instruction over the data bus that connects the processor to the memory system. Because the data bus must be designed to handle word-length transfers as well, the half-word instruction only takes up half the bus width. In the current technology, the bus width can be up to 64-bit, which allows some complicate instructions to make use the full 64 bits. However, it still has many instructions in the type of half-word instruction. It means that, the data bus is not fully used sometime. FIG. 1 is a drawing, schematically illustrating one of conventional format used in an instruction 10 for the processor by a size of 32 bits. In FIG. 1, the 32 bits can be grouped into four 8-bit regions 12-18. The specific bits have the specific meaning. This is determined by the processor configuration. Also, it can include the least significant bits, such as ccc, to indicate the region of bits being used. FIG. 2A is a drawing of instruction with a size of 64 bits having 8 bytes transmitted in a data bus of 64 bits. When a fetch cycle is met, the data bus with 64 bit channels are powered on to transmit data from a usual memory device. When a half-word instruction is desired as show in FIG. 2B, the half-word instruction only uses the address lines of [31:0] and the other are empty. However, according to the conventional method, even the part is empty, all of the 64 address lines are always powered at each of the fetch cycles.

From power consumption point of view, the bus for each bit needs a power to activate the bus for fetching the content belonging to these bits from the memory system. Even though the bus with a width of 64 bits is faster, in operation, than the bus with, for example, 32 bits, the power consumption is larger than that of the bus in 32 bits. Since the processor in operation is very busy, the power consumption will be transformed into the heat. If the processor is operated in the overheat environment, the processor will be easily damaged. For example, when a half-word instruction only takes up 32 bits in the data bus with a width of 64 bits, it will waste the 32 bits in power. Even if the instruction is in one or two bytes, then the waste of power is more serious.

As the word-length of data bus is getting larger, it will have more power waste to turn on the whole data bus in each fetching cycle. The temperature of the processor would be more difficult to control. In some situation for a notebook computer system, since it sometime is power by the battery. If it consumes too much power, the duration of operation will be reduced. This causes inconvenient of the notebook personal computer. The data bus is then desired to have low-power consumption.

In order to save the power for the word-based processor, the conventional method to fetch the instruction should be modified.

### SUMMARY OF THE INVENTION

An object of the invention is to provides a method for fetching a word instruction in a word-based processor for saving the power consumption while the data bus is used to fetch the instruction by the processor.

As embodied and broadly described herein, the invention provides a method for fetching at least one word instruction in a word-based processor. The word instruction includes several types of a full-word instruction or a half-word instruction. The processor employs a data bus with a word length in bit. The method includes dividing the word length into a plurality of world units. Each of the word units has a size of 2ⁿ bits. The processor checks the memory request to obtain whether or not the word instruction to be fetched is in a first type address or a second type address, where the first type address is a sequential half-word aligned address and the second type address is other than the first type address. If the word instruction is at the second type address, the processor fetch the word instruction at each fetch cycle. If the word instruction is at the first type address, then the processor fetches the sequential multiple half-word instructions at the same time in full word length at a first fetch cycle. The half-word instructions are stored in the word units. Then, the half-word instructions are executed without directly fetching the half-word instructions from the memory in each the fetch cycles.

In the foregoing method, the second type address includes a word aligned address and a non-sequential address. The non-sequential address means a jump from a normal sequential code.

In the foregoing method, the size of the word unit is 8 bits, 16 bits or 32 bits.

The invention also provides a circuit suitable for fetching the sequential half-word instructions with saving power for the data bus with a word length in bits. The circuit includes a multiplexer, a flip-flop unit, an OR logic gate. The multiplexer has a first input terminal for receiving a memory data in the full word length and a second input terminal for receiving a recirculated portion of the word length feedback from an output of the flip-flop unit. The OR logic gate receives a word-aligned signal and a non-sequential signal, and exports a selection signal to the multiplexer to select data from one of the first and second input terminals. The output of the multiplexer is transmitted to the flip-flip unit. The flip-flip unit exports an instruction in full word length and also feeds back the recirculated portion of the word length to the multiplexer.

In the forgoing circuit, the word length is 64 bits, and the recirculated portion of the word length has a size of 2ⁿ bits, and preferably has 32 bits at the portion of [63:32].

It is to be understood that both the foregoing general description and the following detailed description are exemplary, and are intended to provide further explanation of the invention as claimed.

### BRIEF DESCRIPTION OF DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a drawing, schematically illustrating one of conventional format used in an instruction for the processor by a size of 32 bits;

FIG. 2A is a drawing of instruction with a size of 64 bits having 8 bytes transmitted in a data bus of 64 bits;

FIG. 2B is a drawing of a half-word instruction with a size of 64 bits but 32 bits are empty;

FIG. 3 is a word instruction with a size of 64 bits, according to a preferred embodiment of the present invention;

FIG. 4A is a content of a word instruction including two sequential half-word instructions, according to a preferred embodiment of the present invention;

FIG. 4B is a content of a word instruction including 8 half-word instructions in a unit of byte, according to a preferred embodiment of the present invention; and

FIG. 5 is a circuit diagram, schematically illustrating the circuit to perform the fetching method for the instruction, according to a preferred embodiment of the present invention.

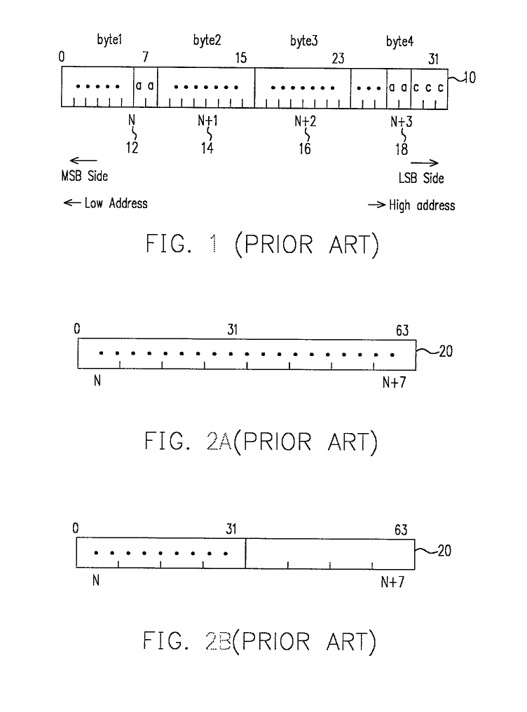

### DETAILED DESCRIPTION

In order to saving the power consumption for operating the data bus, the present invention introduces a method to fetch the sequential half-word instructions at the same time in a word-based processor. As a result, it is not necessary to fetch single one of the sequential half-word instructions at each fetch cycle. Here, the half-word instruction in general means an instruction, which only uses up a portion of the data bus. The half-word instruction is not necessary to be exactly equal to half-length of the full word instruction. The word length means the number of bits being used in the data bus. A data bus with a size of 64 bits is to be taken as an example for descriptions. In this data bus, the half-length of word length preferably is 32 bits but it can be any 2ⁿ bits in general aspect.

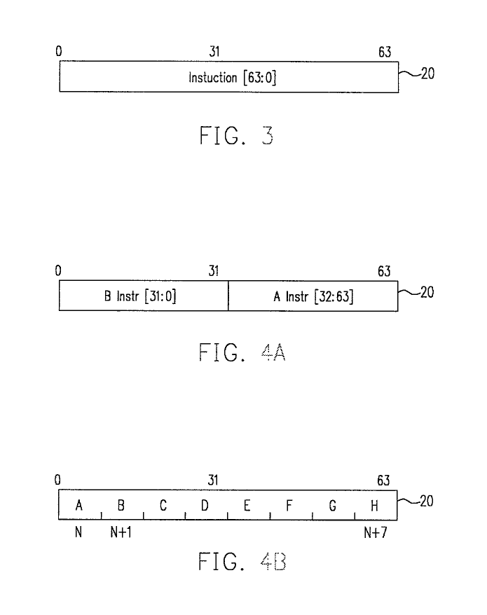

FIG. 3 is a word instruction with a size of 64 bits, according to a preferred embodiment of the present invention. In FIG. 3, the word instruction 20 has a size of 64 bits [63:0]. As skilled artisans known, the instruction can be described written in a word-based format. The length of the instruction is not necessary to the full word size, such as 64 bits. Often, some instructions only use, for example, 32 bits to define it. This kind of instruction is called half-word instruction.

When the half-word instructions are appear in sequence, the invention first introduce the method to fetch the sequential half-word instructions at the same time using the full size of 64 bits. For example, FIG. 4A is a content of a word instruction including two sequential half-word instructions, according to a preferred embodiment of the present invention. In FIG. 4A, two sequential half-word instructions BA are simultaneously fetched in one fetch cycle. In this manner, there is no empty bit in the data bus. Then, the following concerning in the invention is to decouple the two sequential half-word instructions. As one can see, the second half-word instructions A can be executed without actually fetching the memory data from a memory device for this instruction at the separated fetch cycle. As a result, the power consumption for the next fetch cycle is saved. The following descriptions provide an example for arrange the instruction data.

In the conventional method, two sequential half-word instructions need to power on the data bus twice to fetch the two instructions in two fetch cycle. In the example of the invention, only one fetch cycle is sufficient to fetch two sequential instructions. The power is naturally save. Under the normal operation, half-word instructions are fetched incrementally with each instruction address following the previous address by (# of bits in a half-word)/8. For a half-word with 32 bits, the address incremental is 4. In one actual situation, when fetching a specific instruction address, the corresponding half-word instruction resides on the upper half of the data bus. In order to use the method of the invention to fetch two half-word instructions simultaneously, the second instruction preferably is saved at the upper half-word of the instruction register. And, the second instruction is recirculated back to the lower half-word of the instruction of the instruction register in the next cycle. Therefore, it is not necessary to access the memory device for every instruction fetch cycle.

The above method can be generally scaled to handle any instruction size by a form of (word length)/2ⁿ, where n is intrinsically known as a positive integer, preferably is 3, 4, or 5, which equivalent to 8 bits, 16 bits, or 32 bits. Therefore for a 64-bit processor, the method could be modified into handle 64/2 ³=8 bit instructions by dividing a single world into 8 8-bit instructions. FIG. 4B is a content of a word instruction including 8 half-word instructions in a unit of byte, according to a preferred embodiment of the present invention. In FIG. 4B, there are eight half-word instructions. It should be noted as previously mentioned that the half-word instruction in general is a partial-word instruction. In this case, after the word instructions with full length is fetched, one instruction would be used immediately, while the other seven instructions would be saved and used at the appropriate time.

According the method of the invention, the maximum power saving occurs while fetching the sequential half-word instructions. Each one of the sequential half-word instructions only occupied a portion or preferably half of the memory accesses. In the above example, in memory access can fetch two sequential half-word instructions. It save one time of power in the fetch cycle while comparing with the conventional method. This cut power consumption associated with accessing memory in half. Basically, any non-sequential address is preferably still requesting a memory access to reducing the complication in arranging the data. However, it is still possible to access memory data under the same feature to fetch two half-word instructions but not in sequence.

In general, the word instruction address can include, for example, three types.

One type is the sequential half-word instruction having been described above. The second type is the foregoing non-sequential address, which means a jump from normal sequential code. It can also means that the address is seprated from the previous address by an incremental, such as 4 or not at the place of program counter (PC)+4. The third type is the word-aligned address, which is a special one and is always to be fetch by itself at the fetch cycle.

Table 1 summaries the situation to known whether a memory request is made.

TABLE 1
[t1]

| Address | Memory request? |
|---|---|
| Word-aligned address | Yes |
| Non-sequential address (i.e. not PC + 4) | Yes |
| Sequential non word-aligned address, i.e. PC + 4 | No |

In Table 1, when the sequential half-word instructions are desired, the sequential half-word instructions in full available word length can be simultaneously fetched, and then decoupled in the following fetch cycle without actually accessing the memory device through the data bus. Since the word-aligned address and the non-sequential address need to access the memory device to fetch the instruction, these two types can be treated as the same processing type. The sequential non word-aligned address is categorized as a first type address, and the other two are treated as a second type address.

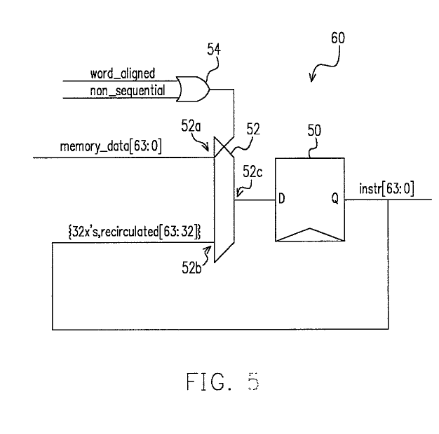

The invention also provide a circuit structure to perform the method of the invention described above. FIG. 5 is a circuit diagram, schematically illustrating the circuit to perform the fetching method for the instruction, according to a preferred embodiment of the present invention. In FIG. 5, The circuit 60 suitable for fetching the sequential half-word instructions with saving power for the data bus with a word length in bits is shown. The circuit 60 includes a multiplexer 52, a flip-flop unit 50, and an OR logic gate 54. The multiplexer 52 has a first input terminal 52a for receiving a memory data in the full word length such 64-bit [63:0]. The multiplexer 52 also has a second input terminal 52b for receiving a recirculated portion of the word length feedback from an output of the flip-flop unit 50. The OR logic gate 54 receives a word-aligned signal and a non-sequential signal, and exports a selection signal to the multiplexer 52 to select data from one of the first and second input terminals 52a, 52b. The output of the multiplexer 52 is transmitted to the flip-flip unit 50. The flip-flip unit 50 exports desired instruction, for example, in full word length and i.e. also feeds back the recirculated portion of the word length to the multiplexer.

As previously mention in FIG. 4B, the method of the invention can be scaled into handle the proper size, as a word unit with a size of 2ⁿ bits, such as 8-bit. Therefore, the recirculated portion is not necessary to be the address [63:32] in 32 bits. The output of the flip-flop 50 can be the desired instruction. For the OR logic gate 54, it basically check whether the current instruction is a first type address or a second type address. If the output of the OR logic gate 54 is false, it also means that the data for the recirculation portion is selected.

Table 2 is an example for the actual operation in 64 bits with a size of 32 bits for the half-word instruction.

TABLE 2
[t2]

| Address | Memory Request? | Memory Data [63:0] | Instruction [1:0] |
|---|---|---|---|
| 00000000 | Yes | BA | A |
| 00001000 | No | — | B |
| 00010000 | Yes | DC | C |
| 00011000 | No | — | D |
| 00100000 | Yes | FE | E |
| 10001000 | Yes (non-seq.) | ML | M |
| 10010000 | Yes | ON | N |
| 10011000 | No | — | O |

In summary, the invention introduce the fetching method for sequential fetching half-word instructions simultaneously in full word size at the first fetch cycle. When the process at the next fetch cycle, the corresponding one of the instruction is taken out for execution without actually access the memory data through the data bus. As a result, the power consumption is significantly cut.

It will be apparent to those skilled in the art that various modifications and variations can be made to the structure of the present invention without departing from the scope or spirit of the invention. In view of the foregoing, it is intended that the present invention covers modifications and variations of this invention provided they fall within the scope of the following claims and their equivalents.

1. A method for fetching at least one word instruction from a memory in a word-based processor, wherein the word instruction includes types of a full-word instruction or a half-word instruction, the processor employs a data bus with a word length in bit, the method comprising:
dividing the word length into a plurality of world units, wherein each of the word units has a size of 2ⁿ bits;
checking a memory request to know whether or not the word instruction to be fetched is in a first type address or a second type address, wherein the first type address is a sequential half-word non-aligned address and the second type address is other than the first type address;
fetching the word instruction at each of fetch cycles, if the second type address is a current status;
fetching the sequential half-word instruction simultaneously in the full word length at a first fetch cycle, if the word instruction is at the first type address, wherein the half-word instructions are stored in the word units; and
executing the half-word instructions without directly fetching the half-word instructions from the memory in next fetch cycles to the first fetch cycle.

2. The method of claim 1, wherein the second type address comprises a word aligned address and a non-sequential address.

3. The method of claim 2, wherein the non-sequential address is an address not following a previous address by one word unit.

4. The method of claim 1, wherein the sequential half-word non-aligned address is an address following a previous address by one word unit.

5. The method of claim 1, wherein the size of the word unit is 8 bits, 16 bits or 32 bits.

6. The method of claim 1, wherein the full world instruction has a size of 64 bits and the half-word instruction has a size of 32 bits.

7. The method of claim 1, wherein the step of executing the half-word instructions comprises obtaining instruction addresses with respect to the half-word instructions and getting contents of the half-word instructions.

8. A circuit structure suitable for fetching word instructions in a word-based processor, which employs a data bus with a word length in bits, the circuit comprising:
a multiplexer;
a flip-flop unit; and
an OR logic gate,
wherein the multiplexer has a first input terminal for receiving a memory data of the word instructions in the full word length and a second input terminal for receiving a recirculated portion of the word length feedback from an output of the flip-flop unit,
wherein the OR logic gate receives a word-aligned signal and a non-sequential signal, and exports a selection signal to the multiplexer to select data from one of the first and second input terminals,
wherein the output of the multiplexer is input to the flip-flip unit, and the flip-flip unit exports a desired instruction and the recirculated portion of the word length is fed back to the multiplexer,
whereby when the recirculated portion of the word length is selected at the multiplexer, the processor is not necessary to actually fetch the memory data.

9. The circuit of claim 8, wherein the recirculated portion of the word length has a size of 2ⁿ bits.

10. The circuit of claim 9, wherein the size of the recirculated portion of the word length includes 8 bits, 16 bits, or 32 bits.

11. The circuit of claim 8, wherein the non-sequential signal is an address not following a previous address by a size of the recirculated portion of the word length.

12. The circuit of claim 8, wherein when the output of the OR logic gate is a false state, it indicates that the word instruction is a type of sequential half-word instructions.

13. A circuit structure suitable for fetching word instructions in a word-based processor, which employs a data bus with a word length in bits, wherein the
word length can be divided into a plurality of word units with a size of 2ⁿ bits, the circuit comprising:
a multiplexer;
a flip-flop unit; and
an OR logic gate,
wherein the multiplexer has a first input terminal for receiving a memory data of the word instructions in the full word length, and a second input terminal for receiving a portion of the word length in the word units feedback from an output of the flip-flop unit,
wherein the OR logic gate receives a word-aligned signal and a non-sequential signal, and exports a selection signal to the multiplexer to select data from one of the first and second input terminals,
wherein the output of the multiplexer is input to the flip-flip unit, and the flip-flip unit exports a desired instruction and a portion of the word length not being used is fed back to the multiplexer,
whereby when the recirculated portion of the word length is selected at the multiplexer, the processor is not necessary to actually fetch the memory data.

14. The circuit of claim 13, wherein the recirculated portion of the word length has a size of 8 bits, 16 bits, or 32 bits.

15. The circuit of claim 13, wherein the non-sequential signal is an address not following a previous address by a size of the recirculated portion of the word length.

16. The circuit of claim 13, wherein when the output of the OR logic gate is a false state, it indicates that the word instruction is a type of sequential half-word instructions.
